(19) United States
(12) Patent Application Publication
(10) Pub. No.: US 2012/0037164 A1
(43) Pub. Date: Feb. 16, 2012

(54) SODIUM TALLOWATE SOAP CUSHION

(76) Inventor: Erik Ahlberg, Sanford, FL (US)

(21) Appl. No.: 13/181,370

(22) Filed: Jul. 12, 2011

Related U.S. Application Data
(60) Provisional application No. 61/373,096, filed on Aug. 12, 2010.

(51) Int. Cl. A61G 15/10; A47C 20/02

(52) U.S. Cl. 128/845; 5/652

(57) ABSTRACT

An apparatus and method for relieving discomfort arising from body aches and pains is disclosed, comprised of a cushion that may be placed on a mattress, sofa, or other furniture and covered with a sheet. Alternatively, said cushion can be part of a mattress, sofa, or other resting surface, including a pet bed. The inventive cushion further comprises compartments into which hard soaps substantially comprised of Sodium Tallowate are inserted. When a body part rests on the cushion with Sodium Tallowate hard soap, vapors form to relieve pain in the body part. Preferably, the cushion comprises multiple sets of large compartments, inside of which are four circular sub-compartments and a central compartment. Hard disc-shaped soaps comprising Sodium Tallowate are inserted into the four circular sub-compartments and vapors accumulate in the central compartment.

### CROSS-REFERENCE TO RELATED APPLICATION

Applicant claims the benefit of provisional patent application No. 61/373,096 filed on Aug. 12, 2010.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The invention relates to an apparatus and method for relieving discomfort arising from body aches and pains, including Restless Leg Syndrome (RLS), Leg Cramps, Athritis, Joint pain, Fibromyalgia, Body aches & pains. The invention comprises a foam cushion that may be placed on a mattress, sofa, or other furniture and covered with a sheet. Alternatively, said cushion can be part of the mattress, sofa, or other resting surface. The invention further comprises compartments in which soap containing high amounts of Sodium Tallowate (apprx. 70%) is inserted. When the soap is inserted into the compartments, vapors are believed to assist in the alleviation of body aches and pains. The portion of the body experience discomfort may be rested on the cushion or be in close proximity to the soap. The cushion comprises numerous compartments spread throughout the cushion so that the user can utilize more than one soap and tailor the location of the soap to target certain body parts.

24 million people in the USA suffer from Restless Leg Syndrome (RLS). RLS is a poorly understood and debilitating disorder which is characterized by an uncontrollable urge to move legs at rest. RLS is often described by sufferers as a fidgety, burning, creeping, jumpy or tingly sensation. Many feel like insects are crawling inside their legs and symptoms are often quite painful. Most people that suffer from RLS also suffer from severe leg cramps. Both disorders seem to occur together and are usually experienced at night while lying in bed. People with these disorders experience sleeplessness, insomnia, mental distress, reduced concentration, and decreased performance. This is because most people with these conditions only get an average of 2 hours sleep.

The most common form of therapy are Narcotics which have side effects more harmful then RLS itself. The most prescribed drugs are Requip, Miroplex, Pergoglide and Quinine (which was banned by the FDA). In addition to Narcotics, many sufferers will self-medicate and/or experience heavy use of sleeping pills.

As an alternative to narcotics, sufferers of these conditions have discovered a home remedy in the form of soap. The medical community is uncertain as to the use of soap as a relief for body discomfort, yet many have experience relief from it. Some soaps appear to work better than others, but it is believed to be Sodium Tallowate, an ingredient in soap, that produces a response in the body that alleviates body pain resulting from RLS and leg cramps. It is also conceivable that the key ingredient is the lye content found in Sodium Tallowate that helps to relieve body aches and pains. Thus, the use of soap in proximity to the human body has increasingly become a home remedy as an alternative to conventional medicine.

Sodium Tallowate is believed to provide relief in one of two manners and/or a combination of both. First, Sodium is an electrolyte. It helps prevent cramping because it is absorbed through the skin (similar to the effects that Gatorade has in crampe relief when ingested). Second, Sodium is Ionic, which means that it is held together by charged bonds. Ions play important roles in the body's physiological processes. Sodium is important for osmoregulation and fluid maintenance in the human body. It plays a pivotal role in enzyme operation and muscle contraction. These ionic bonds may have a positive effect on the body's electrical charge, nerve impulses and metabolic functions.

Known are application Ser. Nos. 11/059,857 and 11/316,053 filed by Ough. Ough comprises a patch and a treatment method for the treatment of human discomforts includes transdermal administration of components from soap in the area of discomfort. The patch includes a permeable layer placed against the person, and an impermeable outer cover, and may include tails by which the patch is attached to the person. Fragments of soap or scent extract from soap are held in close proximity to the area being treated.

Rather than utilizing a patch, the present invention can cover a broader area of the body as the size of the cushion can be as large as the size of a mattress, sofa, chair, or pet bed (as the invention can also be used to treat animals). Moreover, more than one compartment is preferred so that the location and the number of soaps can be tailored to the user's areas of discomfort. Thus, the inventive apparatus can accommodate a higher than usual amount of Sodium Tallowate. Finally, when soap is inserted into a compartment within the cushion, and a leg or other body part is placed over the compartments, the temperature within the cushion increases to approximately 85% (generated by the body's normal temperature of 98.6 degrees), which assists in the release of sodium vapors for absorption into the body.

The preferred dimensions of the inventive cushion are 1″ thick×12″ width×24″ length. In this way, users can place the inventive cushion comprising compartments on top of a mattress or chair. If built into and incorporated into the top surface of a bed mattress or a chair, the dimensions would be that of the corresponding bed or chair. Both the invention cushion or mattress, as well as its compartments may comprise various shapes, e.g., round, square, rectangular, triangular, etc. A compartment, for example, may take the form of 3″×3″ cubes, and 1″ thick or circles approximately 2.80 inches in diameter.

The preferred embodiment of the invention is a cushion comprised of multiple sets of large compartments. Inside of each large compartment are four circular sub-compartments into which disc-shaped soaps comprising Sodium Tallowate are inserted. The four circular sub-compartments form four corners of a square, and in the center exists an empty space in which sodium vapors can form from the body's heat. The accumulated vapors are then absorbed in the body part resting above the large compartment.

When the invention is a cushion and not a mattress, a user would ideally remove a bed sheet from the corner of a bed to reveal a conventional mattress. The user would then place the inventive cushion on top of the mattress in a location where a body part would be treated, e.g., in the foot/calf area of the bed. At least one hard soap comprising Sodium Tallowate would be inserted into at least one compartment of the inventive cushion. The user then places the bed sheet over the inventive cushion. The user then rests his feet/calves over the inventive cushion covered with the bed sheet. The user can then sleep in this manner. The user's skin never actually touches or comes in contact with the soap, although there is no known side effect from skin contact with soap comprising Sodium Tallowate.

### SUMMARY

The invention relates to an apparatus and method for relieving discomfort arising from body aches and pains, including Restless Leg Syndrome (RLS), leg cramps, athritis, joint pain, Fibromyalgia, etc., and comprises a cushion that may be placed on a mattress, sofa, or other furniture and covered with a sheet. Alternatively, said cushion can be part of a mattress, sofa, or other resting surface, including a cushion for animals. The inventive cushion further comprises compartments in which hard soaps containing high amounts of Sodium Tallowate (apprx. 70%) are inserted. Vapors formed by the body's proximity to the hard soap forms sodium vapors which are believed to assist in the alleviation of body aches and pains.

Preferably, the cushion comprises multiple sets of large compartments, inside of which are four circular sub-compartments and a central compartment. Hard disc-shaped soaps comprising Sodium Tallowate are inserted into the four circular sub-compartments and vapors accumulate in the central compartment. The accumulated vapors are then absorbed in the body part resting above the large compartment.

### DRAWINGS

FIG. 1 illustrates the preferred embodiment of the inventive cushion with multiple compartments and subcompartments

### DESCRIPTION

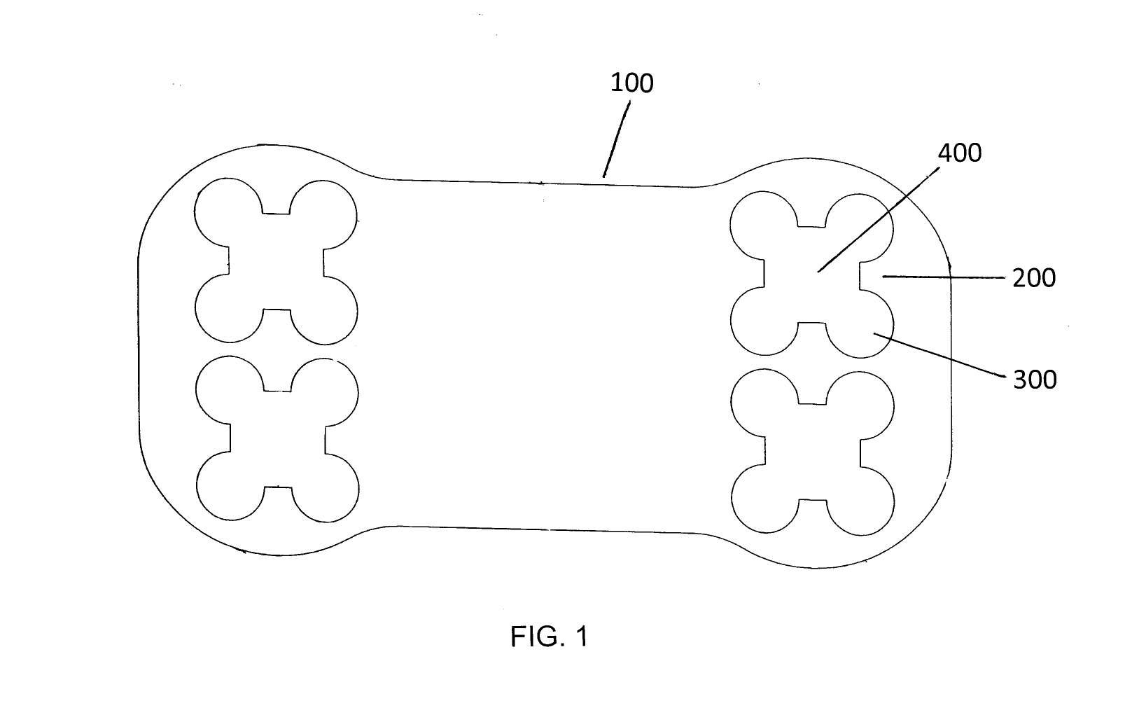

FIG. 1 illustrates the preferred embodiment of the inventive cushion 100 comprised of at least one compartment 200. Within each compartment are subcompartments 300 into which a hard soap (not shown) comprising high amount of sodium tallowate (e.g., 70%) are inserted. The shape and depth of the hard soap and the subcompartment should be substantially the same to avoid shifting of the soap when the inventive cushion 100 is in use. When a user's body part rests on top of the inventive cushion 100 or its subcompartments 300, the body heat forces the release of sodium tallowate vapors (not shown) from the hard soap. The vapors accumulate in a central subcompartment (400), and from there are absorbed into the user's body part directly above the cushion 100. Preferably, a sheet (not shown) would be placed on top of the cushion 100 to separate the user's body part from the hard soap inserted inside the subcompartments 300.

The preferred length of the inventive cushion 100 is 24 inches and the preferred width is 12 inches. Preferably, the inventive cushion 100 is at least 1 inch thick. However, the dimensions and shape of the inventive cushion 100 can vary depending on the surface on which the inventive cushion 100 is placed. It may be round if used as a pet cushion or square if placed on a chair. The inventive cushion 100 can be placed on top of a mattress or chair cushion, or may be incorporated into a mattress or chair cushion.

Furthermore, the inventive cushion may comprise only compartments with no subcompartments, inside of which a hard soap comprising sodium tallowate is inserted. In this embodiment, there is no separate compartment for vapors to accumulate. Nevertheless, can still form from the body's heat and be absorbed into the body part above the compartment.

1. A cushion for treating body aches and pain comprised of at least one compartment into which at least one hard soap substantially comprised of sodium tallowate.

2. The cushion of claim 1, wherein the at least one compartment and the at least on hard soap have corresponding shapes and depths.

3. The cushion of claim 1, in that at least 70% of the hard soap comprises sodium tallowate.

4. The cushion of claim 1, wherein the cushion is a mattress, chair cushion, foam cushion, or pet cushion.

5. The cushion of claim 1, wherein the at least one compartment comprises subcompartments, including at least one subcompartment into which the at least one hard soap comprising sodium tallowate is inserted and at least one subcompartment inside of which sodium tallowate vapors accumulate.

6. The cushion of claim 5, wherein the at least one subcompartment and the at least one hard soap have corresponding shapes and depths.

7. The cushion of claim 6, wherein the at least one compartment comprises four subcompartments proximal to a central compartment inside of which sodium tallowate vapors accumulate.

8. The cushion of claim 7, in which both the four subcompartments and the hard soap are disc shaped.

9. A method of treating body aches and pain utilizing the cushion of claim 1, wherein:
The cushion comprised of at least one compartment is disposed on a resting surface;
The hard soap substantially comprising sodium tallowate is inserted into the at least one compartment;
A sheet is placed over the cushion; and
A user's body or body part is placed on top of the sheet and rests on top of the sheeted cushion.
